(19) United States
(12) Patent Application Publication
(10) Pub. No.: US 2019/0266216 A1
(43) Pub. Date: Aug. 29, 2019

(54) DISTRIBUTED PROCESSING OF A LARGE MATRIX DATA SET

(71) Applicant: TIBCO Software Inc., Palo Alto, CA (US)

(72) Inventor: Sayan Chakraborty, Tulsa, OK (US)

(21) Appl. No.: 15/908,552

(22) Filed: Feb. 28, 2018

(51) Int. Cl. G06F 17/16; G06N 5/04

(52) U.S. Cl. CPC G06F 17/16; G06N 5/04

(57) ABSTRACT

Distributed processing of a large matrix data set is disclosed. In various embodiments, a matrix having a plurality of entries having data values and a plurality of entries for which there are no data values is split into a plurality of chunks balanced based at least in part on a distribution of entries across the matrix. Each of the respective chunks is sent to a corresponding worker computer, processor, or thread configured to perform alternative least squares (ALS) processing with respect to the chunk. Results are received from each of the respective worker computers, processors, or threads. The respective results are combined to determine a predicted value for at least a subset of the missing entries of the matrix.

### BACKGROUND OF THE INVENTION

A common challenge in many data processing applications is to reduce the dimensionality of the data to a manageable size. For example, in recommendation systems such as those commonly used to provide recommendations in the context of consumer-facing electronic commerce websites, propensity to purchase predictions are made for possibly millions of customers and tens of thousands of products, based on a sparse but very large customers-by-products matrix of prior purchases. For example, a movie rental/streaming service famously challenged third party developers to derive useful movie recommendations based on 480,000 randomly selected users and their ratings of the movies each had viewed and rated from a library of 18,000 movies.

A common solution to such a problem is to apply an efficient matrix factorization algorithm to the sparse data, to complete the missing ratings with expected ratings based on a lower-dimensional projection of the data. Beyond recommendations, there are many domains where very large numbers of observations and parameters/variables need to be represented in a lower-dimensional system.

Known techniques to solve the problem of determining missing elements of a large, sparsely populated data matrix may take an unacceptably long time to run or may fail to run, due to the very large amount of memory required to read the matrix into memory and the processing resources required to perform the factorization and compute the missing elements.

### BRIEF DESCRIPTION OF THE DRAWINGS

Various embodiments of the invention are disclosed in the following detailed description and the accompanying drawings.

FIG. 1 is a block diagram illustrating an embodiment of a distributed system to predict values for missing entries of a sparsely populated very large data matrix.

FIG. 2 is a diagram illustrating an example of a sparsely populated matrix and factorization thereof, such as may be performed more efficiently by embodiments of a distributed matrix completion system as disclosed herein.

FIG. 3 is a flow chart illustrating an embodiment of a process to predict values for missing entries in a sparsely populated data matrix.

FIG. 4 is a flow chart illustrating an embodiment of a process to detect that a data matrix is sparsely populated.

FIG. 5 is a diagram illustrating an example of a data structure to store a sparsely-populated matrix.

FIG. 6 is a diagram illustrating an example of splitting a sparsely populated matrix into balanced chunks based on observation topology.

FIG. 7 is a flow chart illustrating an embodiment of a process to split a sparsely populated matrix into balanced chunks based on observation topology.

FIG. 8 is a diagram illustrating an example of splitting a sparsely populated matrix into balanced chunks based on observation topology.

FIG. 9 is a block diagram illustrating an embodiment of a computer system configured to split a sparsely populated matrix into balanced chunks based on observation topology.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques to efficiently compute missing entries for a sparsely populated data matrix are disclosed. In various embodiments, a computer programmatically and efficiently splits a sparse matrix into balanced chunks based on the entry topology of the matrix, i.e., how many entries exist and the manner in which they are distributed throughout the matrix. For example, in some embodiments, a sparse matrix is split into balanced chunks by iteratively adding observed elements appeared in the columns or rows to a chunk until a target number of observations are included in the chunk. The balanced chunks are distributed to worker computers (processors, threads, etc.) to perform alternating least squares (ALS) and/or other factorization-based processing. The results are combined to compute expected values for at least a subset of the missing entries of the original matrix. This approach puts no impact on the correctness as the induced intermediate computations become independent over the different portions of the observed matrix.

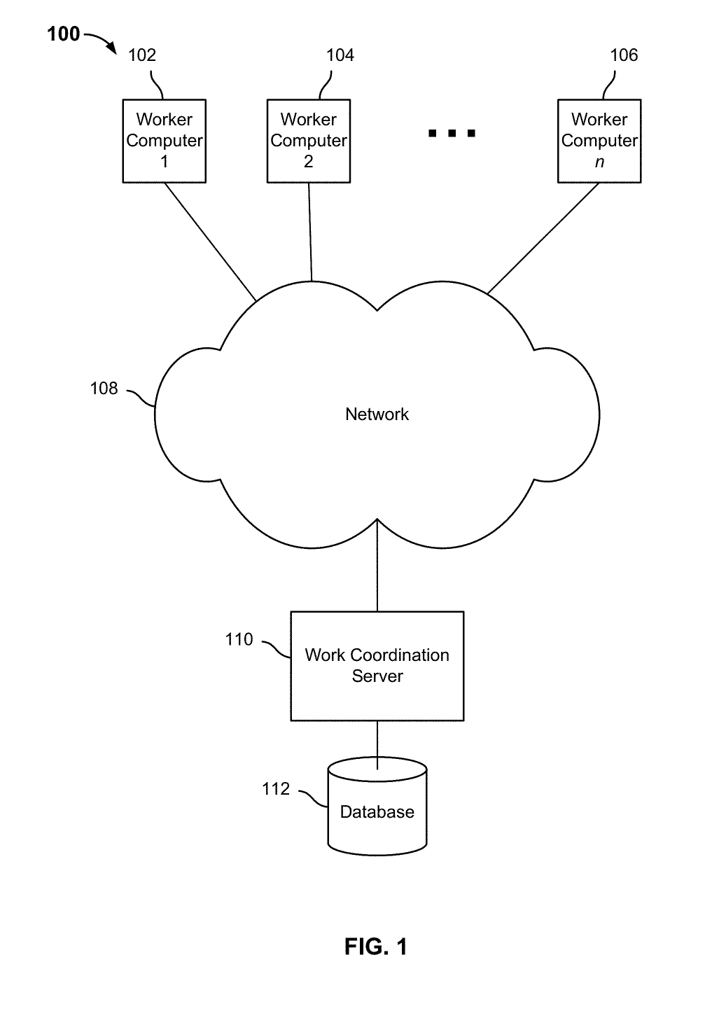

FIG. 1 is a block diagram illustrating an embodiment of a distributed system to predict values for missing entries of a sparsely populated very large data matrix. In the example shown, distributed system 100 includes a plurality of worker computers (processors, threads, etc.), represented in FIG. 1 by computers 102, 104, and 106. Computers 102, 104, and 106 are connected via network 108 to a work coordination server 110. In various embodiments, work coordination server 110 is configured to split a large, sparsely-populated data matrix stored in database 112 into balanced chunks to be distributed to worker computers, such as computers 102, 104, and 106, for processing. Work coordination server 110 receives the respective results from the worker computers (e.g., computers 102, 104, and 106), and combines the result to provide predicted/expected values for entries previously not populated in the data matrix.

In various embodiments, work coordination server 110 may comprise a recommendation system configured to determine recommendations by predicting values for entries missing in a sparsely-populated matrix of content and/or product ratings provided by a population of users, each with respect to the relatively few items that particular user has rated.

In another example, work coordination server 110 coordinates distributed processing of a satellite or other image, in which regions of interest may be distributed unevenly and large regions may be devoid of information, such as the processing of a satellite or other aerial image of a large section of ocean, e.g., to distinguish ice masses from vessels.

In various embodiments, work coordination server 110 is configured to detect that a data matrix is sparsely populated. In various embodiments, work coordination server 110 splits a sparsely-populated, large data matrix into balanced chunks at least in part based on the entry topology of the matrix, for example, based at least in part on where values are present. For example, in some embodiments, the matrix may be split into a number of chunks corresponding to the number of worker computers, processors, and/or threads available to process chunks. The columns and rows to be included in each chunk are determined based at least in part on counts of the number of data values stored in each column/row and/or the remaining portion thereof not yet assigned to a chunk. Resulting chunks each having nearly the same number of entries are distributed for processing to the worker computers, processors, and/or threads, e.g., worker computers represented by computers 102, 104, and 106 in the example shown in FIG. 1. The results are received and combined to determine predicted/expected values for at least some entries missing (i.e., no observed or other data value) in the original matrix.

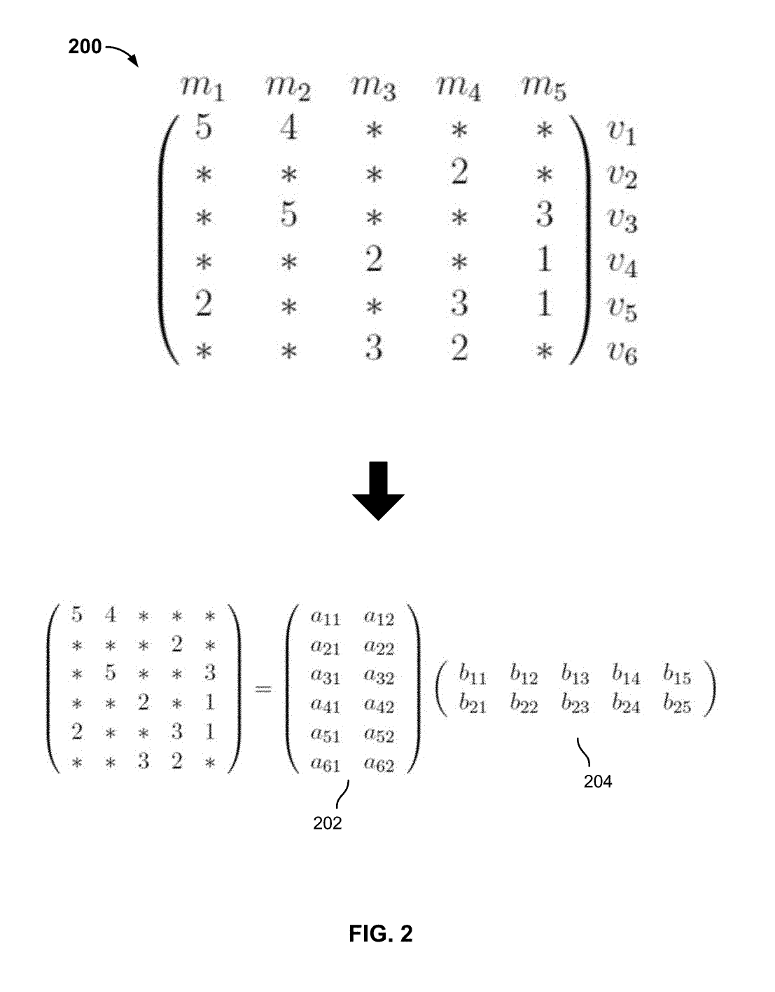

FIG. 2 is a diagram illustrating an example of a sparsely populated matrix and factorization thereof, such as may be performed more efficiently by embodiments of a distributed matrix completion system as disclosed herein. In the example shown, matrix 200 includes a number of data values (entries) distributed unevenly throughout the matrix (e.g., numerical values 1 through 5) and a number of missing entries, indicating in this example by an asterisk (*). Known techniques to reduce the dimensionality of a sparse matrix include techniques, such as alternating least squares (ALS) that involved factoring the matrix into a product of a tall skinny matrix 202 and a short wide matrix 204. The processing of the latter matrices is more tractable than processing the sparse matrix. However, for a very large, sparsely-populated matrix, such as one having millions of rows and tens of thousands of columns, performing such factorization on a single computer may not be practical. For example, the processing may require too much time and/or it may not be possible to read the entire matrix into memory on a single computer. In various embodiments, techniques disclosed herein are used to split a large, sparsely-populated matrix into chunks that are balanced based on the number of observations, and to use distributed computer, processing, and/or threads to perform factorization-based processing on the respective chunks, which results are then combined to determine the underlying model and the predicted/expected values for missing entries.

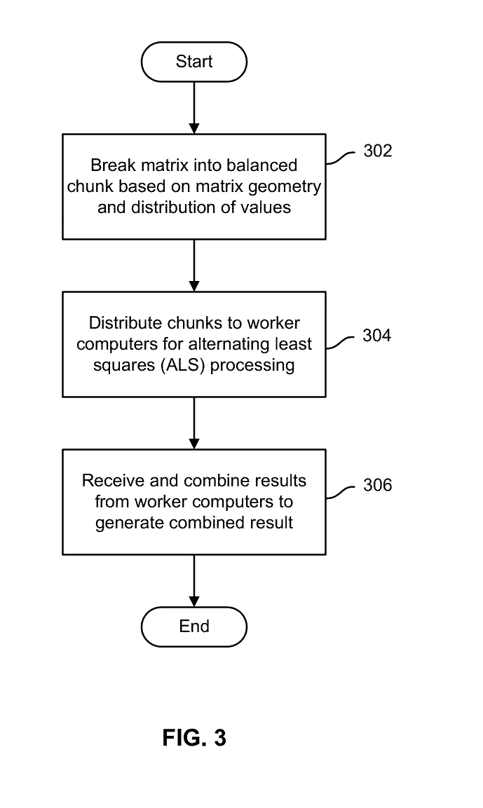

FIG. 3 is a flow chart illustrating an embodiment of a process to predict values for missing entries in a sparsely populated data matrix. In various embodiments, the process of FIG. 3 may be performed by a computer configured to coordinate distributed processing of a large, sparsely-populated matrix to determine predicted/expected values for missing entries, such as the work coordination server 110 of FIG. 1.

In the example shown, a large, sparsely-populated matrix is split into balanced chunks based on matrix geometry and the distribution of values across the matrix (302). In various embodiments, each chunk comprises a contiguous set of cells in one or more adjacent columns and one or more adjacent rows, and each includes an at least substantially similar number of observations. The chunks are distributed to worker computers (processors, threads, etc.) for alternating least squares (ALS) processing (304). Results are received from the respective worker computers and are combined to generate a combined result (306), such as a set of predicted/expected values for at least some entries missing in the original matrix.

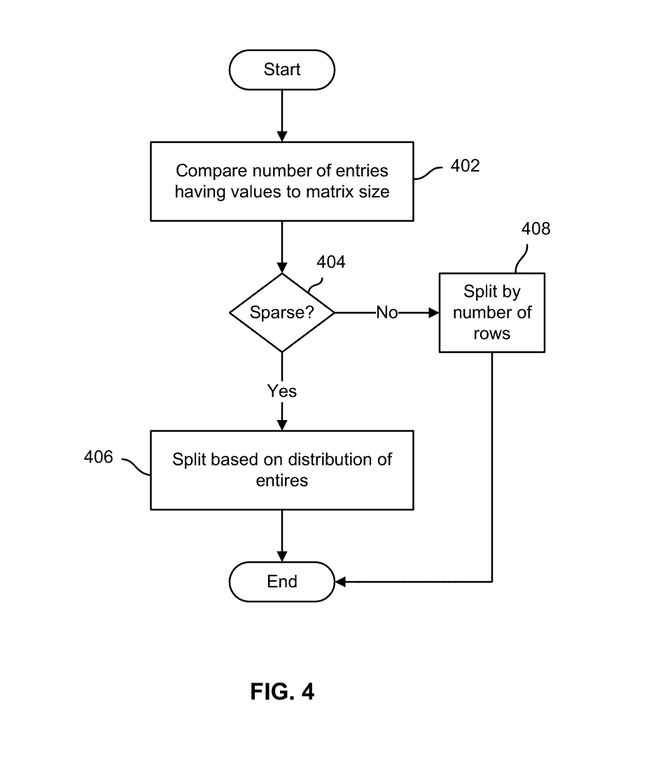

FIG. 4 is a flow chart illustrating an embodiment of a process to detect that a data matrix is sparsely populated. In various embodiments, the process of FIG. 4 may be performed by a computer configured to coordinate distributed processing of a large, sparsely-populated matrix to determine predicted/expected values for missing entries, such as the work coordination server 110 of FIG. 1. In the example shown, for a given matrix the number of entries having data values is compared to the overall size (dimensionality) of the matrix (402). If the comparison indicates the matrix is sparsely populated (404), for example there are a thousand entries with data values but millions of rows and tens of thousands of columns, the matrix is split based on the distribution of observations within the matrix (406), as disclosed herein. If the matrix is determined to not be sparsely populated (404), then a convention row (or column) based split (e.g., equal number of rows in each chunk) is performed (408).

In various embodiments, the process of FIG. 4 enables a system as disclosed herein to revert to row- or column-based splitting of a matrix for which the observation topology-based techniques disclosed herein would yield less benefit.

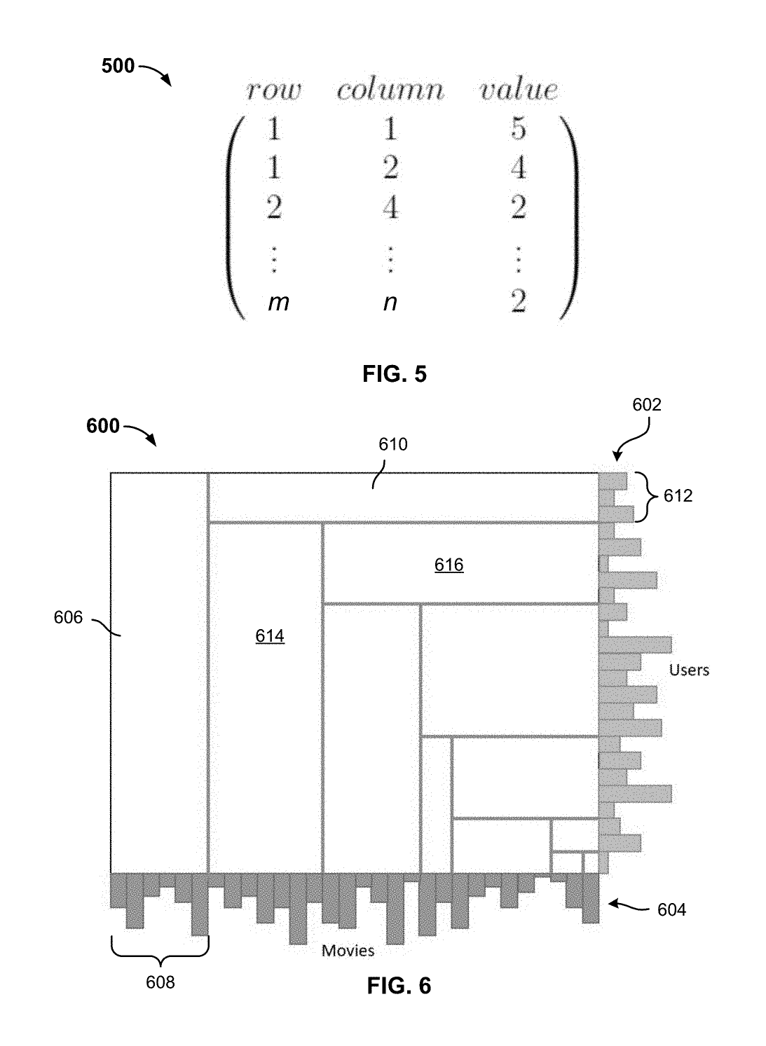

FIG. 5 is a diagram illustrating an example of a data structure to store a sparsely-populated matrix. In various embodiments, values comprising a matrix and the location within the matrix of each may be stored in a data structure 500 as shown in FIG. 5. In some embodiments, a matrix as shown in FIG. 5 may be stored in a database or other storage system, such as the database 112 of FIG. 1. In the example shown, the data structure 500 includes for each entry a row number, a column number, and a data value. Matrix locations for which no data value (or no non-zero data value) exists are not represented explicitly by an element in the data structure 500.

In various embodiments, a data structure such as data structure 500 may be evaluated programmatically to determine the number of entries having a data value, which in this example would be equal to the size of (number of elements included in) the data structure 500, and the overall size of the matrix, which can be computed by multiplying the largest row number m by the largest column number n.

In various embodiments, the data structure 500 is used to compute and update row counts indicating how many entries exist in a row or in a remaining (i.e., not as yet assigned to a chunk) portion of a row and/or column counts indicating how many entries exist in a column or in a remaining (i.e., not as yet assigned to a chunk) portion of a column. In various embodiments, row and/or column counts are used, as disclosed herein, to programmatically split a large, sparsely-populated matrix into chunks that are substantially balanced in terms of number of entries/observations in each chunk.

FIG. 6 is a diagram illustrating an example of splitting a sparsely populated matrix into balanced chunks based on observation topology. In the example shown, a large, sparsely-populated matrix 600 has been split into balanced chunks based at least in part on row counts 602 and column counts 604, indicating respectively how many entries exist in a row or in a remaining (i.e., not as yet assigned to a chunk) portion of a row and how many entries exist in a column or in a remaining (i.e., not as yet assigned to a chunk) portion of a column. In the example shown, a first chunk 606 has been defined based on column counts 608. For example, starting with a first column, additional columns were added iteratively and the column count of the associated column added to a cumulative count until a next column would result in the cumulative count exceeding a threshold, such as a target number of observations per chunk. In some embodiments, the target number is determined by dividing the total number of observations in the matrix by the number of worker computers, processors, and/or threads available to process chunks. Similarly, in this example a next chunk 610 has been defined to include the portions of rows associated with row counts 612 that were not included in chunk 606. In some embodiments, the row counts 602 are updated each time a chunk is defined by iteratively adding columns or remaining portions of columns, such as chunk 606. The updated values reflect how many entries exist in the portion of the row that has not yet been assigned to a chunk. Likewise, column counts 604 are updated each time a chunk is defined by iteratively adding rows or remaining portions of rows to a chunk, such as chunk 610. Alternatively, in a specific case, if the number of worker computers can be expressed in some power of 2 (2^{K}), then the chunks can be made by equal partition thresholding i.e. the target value for splitting any given chunk will be equal to half of the observed entries in that chunk and we split the chunk into two new chunks.

Referring further to FIG. 6, additional chunks 614 and 616 and so one has been defined by iteratively adding columns or rows (or remaining portions thereof) until a next column or row would result in the observation/entry count for the chunk exceeding a target number of observations or other threshold.

In the example shown in FIG. 6, chunks were defined alternately by iterating through columns and rows. In some embodiments, a next chunk is defined programmatically by iterating through columns or rows depending on whether the portion of the matrix remaining to be assigned to chunks includes more rows than columns or vice versa. For example, in some embodiments, if the remaining portion of the matrix not yet assigned to a chunk includes more rows than columns, the next chunk is defined by iteratively adding adjacent rows to the chunk. In some embodiments, to avoid circumstances due to the uneven distribution of the matrix, a restriction is placed on the maximum tolerance of the chunk size to be 2 times the threshold. Hence, if the if the remaining portion of the matrix not yet assigned to a chunk includes more rows than columns but by adding adjacent rows, the first satisfying split not only exceeds the threshold but exceeds twice of the threshold, a column split is performed instead of a row split and the chunk is defined by iteratively adding adjacent columns to the chunk. If the column split also seems to exceed twice the size of threshold, then the final split is determined based on whichever exceeds the threshold with a minimum chunk size. If instead the remaining portion of the matrix not yet assigned to a chunk includes more columns than rows, the next chunk is defined by iteratively adding adjacent columns to the chunk. In some embodiments, to avoid circumstances due to the uneven distribution of the matrix, a restriction is placed on the maximum tolerance of the chunk size to be 2 times the threshold. Hence, if the if the remaining portion of the matrix not yet assigned to a chunk includes more columns than rows but by adding adjacent columns, the first satisfying split not only exceeds the threshold but exceeds twice of the threshold, a row split is performed instead of a column split and the chunk is defined by iteratively adding adjacent rows to the chunk. If the row split also seems to exceed twice the size of threshold, then we decide the final split based on whichever exceeds the threshold with a minimum chunk size.

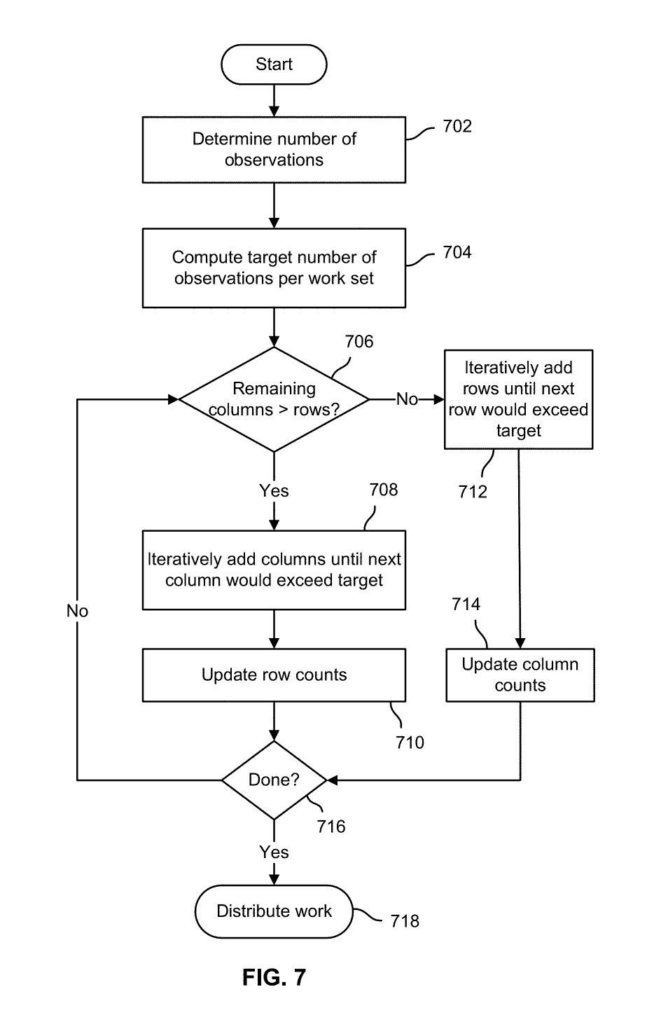

FIG. 7 is a flow chart illustrating an embodiment of a process to split a sparsely populated matrix into balanced chunks based on observation topology. In various embodiments, the process of FIG. 7 may be performed by a computer configured to coordinate distributed processing of a large, sparsely-populated matrix to determine predicted/expected values for missing entries, such as the work coordination server 110 of FIG. 1. In the example shown, the number of observations (i.e., entries having data values) in the matrix is determined (702). For example, the size of a data structure such as data structure 500 of FIG. 5 may be determined. A target number of observations to be included in each chunk (work set) is determined (704), for example by dividing the total number of observations by the number of computers, processors, and/or threads available to process chunks. If the (remaining, i.e., not yet assigned to a work set) number of columns is greater than the (remaining) number of rows (706), then a next chunk is defined by iteratively adding successive, adjacent columns to the chunk until a next column would result in an aggregate observation count of the chunk exceeding a threshold, such as the target determined at step 704 (708). In some embodiments, to avoid circumstances due to the uneven distribution of the matrix, a restriction is placed on the maximum tolerance of the chunk size to be 2 times the threshold. Hence, if the if the remaining portion of the matrix not yet assigned to a chunk includes more columns than rows but by adding adjacent columns, the first satisfying split not only exceeds the threshold but exceeds twice of the threshold, a row split is performed instead of a column split and the chunk is defined by iteratively adding adjacent rows to the chunk. If the row split also seems to exceed twice the size of threshold, then the final split is determined based on whichever exceeds the threshold with a minimum chunk size. If a column split is performed, row counts are updated to reflect columns added to the chunk (710). If instead the (remaining) number of columns does not exceed the (remaining) number of rows (706), then a next chunk is defined by iteratively adding successive, adjacent rows to the chunk until a next row would result in an aggregate observation count of the chunk exceeding a threshold, such as the target determined at step 704 (712). In some embodiments, to avoid circumstances due to the uneven distribution of the matrix, a restriction is placed on the maximum tolerance of the chunk size to be 2 times the threshold. Hence, if the if the remaining portion of the matrix not yet assigned to a chunk includes more rows than columns but by adding adjacent rows, the first satisfying split not only exceeds the threshold but exceeds twice of the threshold, a column split is performed instead of a row split and the chunk is defined by iteratively adding adjacent columns to the chunk. If the column split also seems to exceed twice the size of threshold, then the final split is determined based on whichever exceeds the threshold with a minimum chunk size. If a row split is performed, column counts are updated to reflect rows added to the chunk (714). Successive chunks are defined in the same manner until all portions of the matrix have been assigned to a chunk (716), upon which the each chunk is sent to a corresponding worker computer, processor, and/or thread for distributed processing (718).

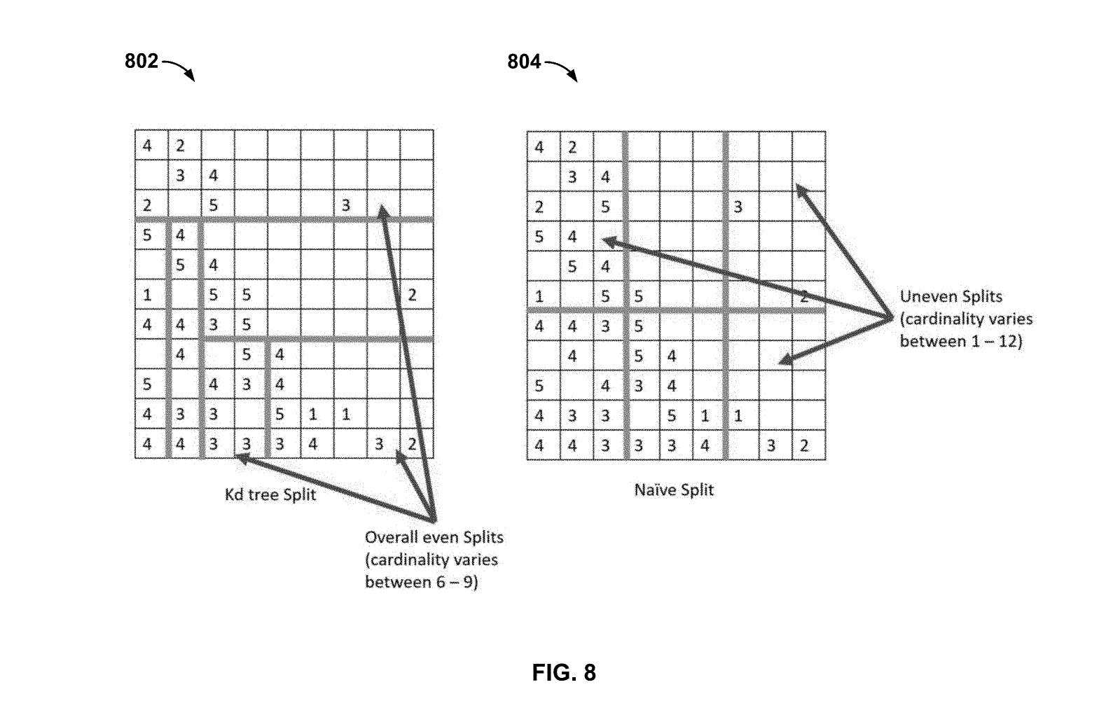

FIG. 8 is a diagram illustrating an example of splitting a sparsely populated matrix into balanced chunks based on observation topology. In various embodiments, the chunks as shown in example 802 on the left of FIG. 8 may be defined via the process of FIG. 7. In the example shown, the matrix has been split into chunks using techniques disclosed herein to yield chunks each having 6 to 9 entries. By comparison, the “naïve” approach, e.g., attempting to define chunks having as near as practical the same number of columns and rows, results in a split shown in example 804 on the right, in which the number of observations per chunks ranges from 1 to 12. Splitting the matrix using techniques disclosed herein, as in the example 802 shown in FIG. 8, results in chunks having a more balanced workload and enables the overall solution to be obtained more quickly, since the worker computers, processors, or threads each have a substantially similar amount of processing work to complete.

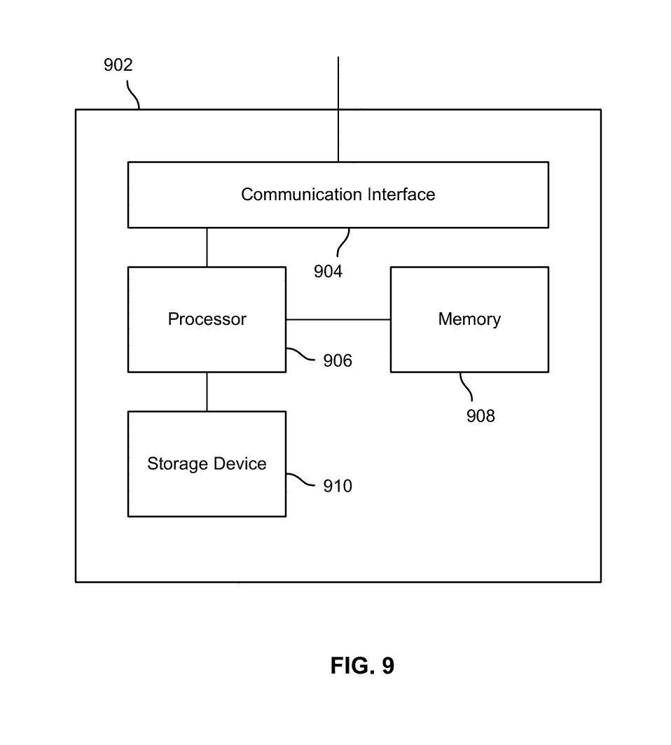

FIG. 9 is a block diagram illustrating an embodiment of a computer system configured to split a sparsely populated matrix into balanced chunks based on observation topology. In various embodiments, techniques disclosed herein may be implemented on a general purpose or special purpose computer or appliance, such as computer 902 of FIG. 9. For example, one or more of the worker computers 102, 104, and 106 and work coordination server 110 may comprise a computer such as computer 902 of FIG. 9. In the example shown, computer 902 includes a communication interface 904, such as a network interface card, to provide network connectivity to other computers. The computer 902 further includes a processor 906, which may comprise one or more processors and/or cores. The computer 902 also includes a memory 908 and non-volatile storage device 910. In various embodiments, techniques disclosed herein enable one or both of the processor 906 and the memory 908 to be used more efficiently to determine predicted/expected values for missing entries in a large, sparsely-populated data matrix.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a memory configured to store data associated with a matrix having a plurality of entries having data values and a plurality of entries for which there are no data values;
a processor coupled to the memory and configured to:
split the matrix into a plurality of chunks balanced based at least in part on a distribution of entries across the matrix;
send each of the respective chunks to a corresponding worker computer, processor, or thread configured to perform alternative least squares (ALS) processing with respect to the chunk;
receive results from each of the respective worker computers, processors, or threads; and
combine the respective results to determine a predicted value for at least a subset of the missing entries of the matrix.

2. The system of claim 1, wherein the processor is configured to split the matrix into a plurality of chunks at least in part by computing a target number of entries per chunk.

3. The system of claim 2, wherein the processor is configured to compute the target number of entries per chunk by determining a total number of entries having data values by a number of computers, processors, or threads.

4. The system of claim 1, wherein the processor is configured to determine that the matrix is sparsely populated.

5. The system of claim 4, wherein the processor is configured to determine that the matrix is sparsely populated by comparing a total number of entries having data values to a size of the matrix.

6. The system of claim 1, wherein the processor is configured to split the matrix into a plurality of chunks at least in part by iterative adding columns or rows to a chunk until a next column or row would result in an aggregate number of entries having data values that exceeds a target number of entries.

7. The system of claim 6, wherein the processor is further configured to compute column counts and row counts reflecting for each column and row, or portion thereof not yet assigned to a chunk, respectively, a number of entries having data values in that column, row, or portion thereof.

8. The system of claim 1, wherein the matrix comprises a sparse set of ratings by each of a plurality of users and wherein the predicted values comprise predicted ratings, and wherein the processor is further configured to use the predicted ratings to determine a recommendation for a user.

9. A method, comprising:
using a processor to split a matrix having a plurality of entries having data values and a plurality of entries for which there are no data values into a plurality of chunks balanced based at least in part on a distribution of entries across the matrix;
using the processor to send each of the respective chunks to a corresponding worker computer, processor, or thread configured to perform alternative least squares (ALS) processing with respect to the chunk;
receiving at the processor results from each of the respective worker computers, processors, or threads; and
combining the respective results to determine a predicted value for at least a subset of the missing entries of the matrix.

10. The method of claim 9, wherein the matrix is split into a plurality of chunks at least in part by computing a target number of entries per chunk.

11. The method of claim 10, wherein the target number of entries per chunk is computed at least in part by determining a total number of entries having data values by a number of computers, processors, or threads.

12. The method of claim 9, further comprising determining that the matrix is sparsely populated.

13. The method of claim 12, wherein the matrix is determined to be sparsely populated by comparing a total number of entries having data values to a size of the matrix.

14. The method of claim 9, wherein the matrix is split into a plurality of chunks at least in part by iterative adding columns or rows to a chunk until a next column or row would result in an aggregate number of entries having data values that exceeds a target number of entries.

15. The method of claim 14, further comprising computing column counts and row counts reflecting for each column and row, or portion thereof not yet assigned to a chunk, respectively, a number of entries having data values in that column, row, or portion thereof

16. The method of claim 9, wherein the matrix comprises a sparse set of ratings by each of a plurality of users and wherein the predicted values comprise predicted ratings, and wherein the predicted ratings are used to determine a recommendation for a user.

17. A computer program product embodied in a non-transitory computer readable medium and comprising computer instructions for:
splitting a matrix having a plurality of entries having data values and a plurality of entries for which there are no data values into a plurality of chunks balanced based at least in part on a distribution of entries across the matrix;
sending each of the respective chunks to a corresponding worker computer, processor, or thread configured to perform alternative least squares (ALS) processing with respect to the chunk;
receiving results from each of the respective worker computers, processors, or threads; and
combining the respective results to determine a predicted value for at least a subset of the missing entries of the matrix.

18. The computer program product of claim 17, wherein the matrix is split into a plurality of chunks at least in part by computing a target number of entries per chunk.

19. The computer program product of claim 18, wherein the target number of entries per chunk is computed at least in part by determining a total number of entries having data values by a number of computers, processors, or threads.

20. The computer program product of claim 17, further comprising computer instructions for determining that the matrix is sparsely populated at least in part by comparing a total number of entries having data values to a size of the matrix.
